(19) United States
(12) Patent Application Publication
(10) Pub. No.: US 2006/0229229 A1
(43) Pub. Date: Oct. 12, 2006

(54) Cleaning composite

(75) Inventors: Julie M. Bednarz, Neenah, WI (US); Fung-jou Chen, Appleton, WI (US); Jeffrey D. Lindsay, Appleton, WI (US); Susan M. Trefethren, Appleton, WI (US); Carl G. Rippl, Appleton, WI (US); Chi Hao P. Duong, Menasha, WI (US); Jonathan K. Arendt, Appleton, WI (US); James A. Walter, Hortonville, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/103,910

(22) Filed: Apr. 11, 2005

(51) Int. Cl. C11D 17/00

(52) U.S. Cl. 510/438

(57) ABSTRACT

A cleaning composite comprising a foam layer, such as melamine foam, and an element adapted to engage a user's hand, is disclosed. The hand-engaging element may be adjustable. A second layer, attached to at least a portion of the foam layer, may also be present. When a second layer is present, the hand-engaging element, in some embodiments, may be positioned in facing relation to a surface of the second layer or a surface of the foam layer.

### BACKGROUND

Cleaning applications employ cleaning products, such as towels, in order to remove dirt and other unwanted elements from surfaces. In some instances the cleaning product may be a urethane foam or a cellulose sponge, which may be used in order to wipe a surface clean. The cleaning product may be configured with bristles or grit disposed thereon in order to aid in cleaning.

Cleaning products can be configured to work when in a dry state in order to clean the surface, or may be designed to work in a wet state so that the cleaning product is wet to some degree when cleaning the surface. A detergent may be used with the cleaning product in order to assist in breaking up dirt and other unwanted elements so that the surface may be cleaned. It is sometimes the case that dirt or other unwanted elements cannot be sufficiently removed from a surface even when a cleaning product is properly applied. Applying the cleaning product too aggressively may result in the surface being damaged, and may still not result in the removal of dirt or unwanted elements from the surface. Examples of difficult-to-clean materials include crayon on walls, scuff marks from shoes on floors, permanent magic marker markings on a variety of surfaces such as dry erase boards, stains on porcelain or ceramics including dentures, grease and oil spots on numerous surfaces, hard water spots and soap scum on tile, biofilms on metal and plastic surfaces, mildew and fungus growths on numerous surfaces, and other forms of dirt, grime, or other unwanted elements from various surfaces.

Blocks of melamine foam have been recognized as having useful cleaning properties when wetted with water and rubbed against certain surfaces to be cleaned, and have been marketed in several countries for such purposes. Melamine-based foam has an open-celled, microporous structure. Melamine-based foam is abrasive in that when rubbed across a surface, dirt and other unwanted elements will be removed. Particles of the melamine-based foam may break off due to this abrasive contact. Over time, the melamine-based foam will be worn down due to repeated abrasion with the surface to be cleaned and the unwanted elements present on this surface.

Melamine-based foam may be used to clean a surface when in a wet state. In this regard, the melamine-based foam may be soaked with water to some degree prior to being applied by a user to the surface to be cleaned. A block of melamine-based foam by itself is sometimes used as a cleaning product. In this regard, the user may grasp the block of melamine-based foam, wet the block in water, and then rub the wetted melamine-based foam across a surface to remove dirt and unwanted elements.

Unfortunately, commercially marketed blocks of melamine-based foam suffer from at least one drawback. It does not appear to have been recognized that a strap or other similar element, adapted to engage a user's hand, can be used in conjunction with, for example, a melamine-based foam to facilitate use of the foam when cleaning and/or treating a surface.

### SUMMARY

We have found that a cleaning composite comprising an element adapted to engage a user's hand (e.g., an elastomeric strap) facilitates use of the foam when cleaning and/or treating a surface.

Various features and advantages of the invention will be set forth in part in the following description.

The present invention provides for a cleaning composite for use in cleaning a surface through wiping or scrubbing, either in a dry state, in the presence of water, or in the presence of other cleaning agents or other compounds. The cleaning composite comprises an element designed to engage a user's hand, e.g., an elastomeric strap under which a user may insert his or her hand, to facilitate use of the composite when cleaning a surface. This hand-engaging element reduces the chance of the cleaning composite being dropped in use. Furthermore, the hand-engaging element may reduce fatigue, as the user will likely not have to grip the cleaning composite as firmly during use. In addition, the hand-engaging element may increase the effectiveness of the cleaning composite, by helping to reduce slippage or movement of the palm-side surface of the hand relative to the surface of the cleaning composite during use of the composite.

The composite includes a layer of a foam such as an aminoplast foam (e.g., foams made from urea-formaldehyde resins or melamine-formaldehyde resins) or a phenolic foam such as a foam made from phenol-formaldehyde resins, wherein the foam has mechanical properties suitable for contacting and cleaning the surface. In some versions of the invention, the hand-engaging element, such as an elastomeric strap, may be attached directly to the foam. Furthermore, the hand-engaging element may be attached to the foam so that the element can be positioned in facing relation to either of the opposing surfaces of the foam layer. This capability is discussed in more detail in the Description section below.

In other versions of the invention, the cleaning composite may comprise a second layer attached to at least a portion of the foam layer. The second layer, such as a hydrophilic fibrous web, film, nonwoven material, plastic, or other such material, may also be included and attached to at least a portion of the foam. If the second layer is a hydrophilic web, it will generally comprise cellulosic fibers and can comprise a paper material such as a latex-reinforced creped towel, an uncreped through-air-dried towel reinforced with wet strength resins or other binding agents, other single-ply or multi-ply tissue structures (multi-ply tissues will generally require interply bonding means such as adhesive attachment for good mechanical integrity), a coform layer comprising wood pulp fibers intermingled with thermoplastic material that has been thermally bonded, and airlaid material comprising bicomponent binder fibers, a hydroknit comprising hydraulically entangled paper fibers on a nonwoven substrate, and the like. The web itself may comprise a plurality of layers bonded together. The web can a provide water retention function to help absorb water in use or to provide water for cleaning when compressed. For the versions of the invention that include a second layer, the hand-engaging element, such as an elastomeric strap, may be attached directly to the foam layer, to the second layer, or both. Furthermore, the hand-engaging element may be attached to the cleaning composite so that the element can be positioned in facing relation to either of the opposing surfaces of the composite. So, for example, the hand-engaging element, e.g., an elastomeric strap, could be positioned so that a user's hand rested against the second layer, with the elastomeric strap engaging the back of the user's hand. In this instance, the user would apply the foam layer of the composite against a surface to treat and/or clean the surface. Alternatively, the strap could be positioned so that the user's hand rested against the foam layer, again with the elastomeric strap engaging the back of the user's hand. In this instance, the user would apply the second layer, e.g., a hydrophilic web, against a surface to treat and/or clean the surface.

The element adapted to engage a user's hand can be adjustable, either because the element is elastomeric, and therefore capable of being stretched to rest snugly against users' hands of various sizes, or because the element comprises components adapted to make the element adjustable. So, for example, the element, such as a strap, could comprise two lengths of material, one end of each length of material being attached to the cleaning composite, and some portion of each length of material being adapted to adjustably engage one another (as with, e.g., a buckle, a mechanical fastening system in which one length of material comprises a loop material, and the other length of material comprises a hook material, such that the hook material and loop material can releasably engage one another; etc.). The embodiments of the preceding paragraphs are discussed in additional detail in the Description section below.

A detailed description of foams made of aminoplasts, i.e., for example, formaldehyde condensation products based on urea, melamine, dicyanodiamide and/or derivatives thereof, are found, for example in Kunststoff-Handbuch, Vol. X, Vieweg-Becker “Duroplaste”, Karl Hanser Verlag, Munich, 1968, pp. 135 et seq., especially 466-475, including the bibliography cited therein. Corresponding information on foams of phenoplasts is found, for example, in Ullmann, Encyklopadie dertechnischen Chemie, 3rd ed., Vol. 15 (1964), pp. 190-1 including the bibliography mentioned therein.

Further, any aminoplast foam or other rigid or brittle foam disclosed in U.S. Pat. No. 4,125,664, “Shaped Articles of Foam Plastics,” issued Nov. 14, 1978 to H. Giesemann, herein incorporated by reference, may be used to produce the products of the present invention. Other foams believed to be useful within the scope of the present invention include those disclosed in U.S. Pat. No. 4,666,948, “Preparation of Resilient Melamine Foams,” issued May 19, 1987 to Woerner et al.; U.S. Pat. No. 5,234,969, “Cured Phenolic Foams,” issued Aug. 10, 1993 to Clark et al.; U.S. Pat. No. 6,133,332, “Process for Producing Phenolic Resin Foams,” issued Oct. 17, 2000 to T. Shibanuma; and WO 91/14731, “Stable Aminoplast Cellular Foams and Process for Manufacturing Them,” published Oct. 3, 1991 by Mäder et al., all of which are herein incorporated by reference. The latter, WO 91/14731, discloses cellular foams obtained by using an unsaturated, halogenated polyalcohol in a resin precondensate constituent and a dodecylbenzolsulphonic acid partially esterified preferably with a fatty alcohol and a long-chain polyhydric alcohol such as a polyethylene glycol, in a foaming agent hardener constituent.

In one embodiment, the cleaning foam comprises a thermoset foam, and the thermoset components of the cleaning foam may comprise over 50%, over 60%, over 80%, or over 90% of the mass of the foam. Alternatively, the solid polymeric components of the cleaning foam may consist essentially of one or more thermoset materials. In another embodiment, the cleaning foam is substantially free of thermoplastic materials. In another embodiment, the cleaning foam does not comprise more than 50% of any one of a component selected from polyolefin materials, polyurethanes, silicones, and polyesters.

Attachment of the second layer to the foam layer can be done using a number of approaches, including, for example, adhesive means suitable for maintaining good flexibility in the product, and with adhesive means that also provide good strength when wet and when repeatedly subject to the stress cycles typical of scrubbing. In one embodiment, the adhesive means comprises a water-insoluble hot melt adhesive material having a Shore A hardness of about 95 or less, specifically about 75 or less, more specifically about 55 or less, more specifically still about 40 or less, and most specifically about 30 or less, such as from about 10 to about 95, or from about 20 to about 55. useful adhesives can include those of U.S. Pat. No. 6,541,679, issued Apr. 1, 2003 to Betrabet et al. and U.S. Pat. No. 5,827,393, issued Oct. 27, 1998 to Kinzelmann et al., as well as the commercial HYSOL® hotmelts of Henkel Loctite Corporation (Rocky Hill, Conn.), including polyolefin, urethane, and polyamide hotmelts. The adhesive can have a glass transition temperature is between −10° C. and +30° C. or between 10° C. and 25° C. The tensile strength of the adhesive may be at least 100 psi, at least 300 psi, or at least 500 psi.

In one embodiment, the adhesive means comprises an adhesive with a plurality of hydrophilic groups suitable for maintaining good adhesion with cellulose even when the cellulose is wet. Such adhesives can comprise EVA (ethylene vinyl acetate), and may include, by way of example, the EVA HYSOL® hotmelts of Henkel Loctite Corporation (Rocky Hill, Conn.), including 232 EVA HYSOL®, 236 EVA HYSOL®, 1942 EVA HYSOL®, 0420 EVA HYSOL® SPRAYPAC®, 0437 EVA HYSOL® SPRAYPAC®, CoolMelt EVA HYSOL®, QuikPac EVA HYSOL®, SuperPac EVA HYSOL®, and WaxPac EVA HYSOL®. EVA-based adhesives can be modified through the addition of tackifiers and other conditioners, such as Wingtack 86 tackifying resin manufactured by Goodyear Corporation (Akron, Ohio).

In another embodiment, the adhesive means comprises an elastomeric adhesive such as a rubber-based or silicone-based adhesive, including silicone sealants and latex adhesives such as acrylic latex. In one embodiment, however, the adhesive means is substantially free of natural latex or proteins associated with natural latex. In another embodiment, the adhesive means is substantially free of any kind of latex.

For reactive adhesives and other adhesives, the “open time” of the adhesive (the time in which bonding to a second surface can be carried out after the adhesive has been applied to a first surface) can be about 10 seconds or greater, 30 seconds or greater, or 5 minutes or greater; alternatively, the open time can be less than 30 seconds such as less than 15 seconds.

The adhesive means can also comprise fibers or particulates that are either tacky or can be heated to melt a portion thereof for fusing the fibrous web to the foams. For example, bicomponent binder fibers may be used, in which a sheath has a lower melting point than a core fiber (e.g., a polypropylene or polyethylene sheath around a polyester core). The binder fibers may be applied in a separated loose form, or may be provided as a prebonded fusible web. In one embodiment, the adhesive means comprises a combination of adhesive particles or fibers such as bicomponent fibers and a hotmelt or reactive adhesive. For example, bicomponent fibers may be present in or on a reinforcing layer prior to application of a hotmelt or other flowable or liquid adhesive (e.g., by spray, extrusions, or printing) to either the reinforcing layer or the foam, followed by joining of the tissue to the foam and optional application of heat or other curing means. The particulate adhesive component may already be active (e.g., partially molten) when the foam is joined to the reinforcing layer.

In general, the adhesive means can be applied by spray nozzles, glue guns, bead applicators, extruders, gravure printing, flexographic printing, ink-jet printing, coating, and the like. The adhesive means can be but need not be uniformly applied on either the surface of the foam or the surface of the web or both, and may be applied selectively in regions where high strength is needed such as along the perimeter of the interfacial area between the web and the foam. The adhesive means can also be applied in a pattern or in a substantially random distribution.

For those versions of the invention comprising a foam layer, a second layer, and an adhesive, Table 1 presents exemplary ranges for the recited component (again, some versions of the invention do not include a second layer):

TABLE 1
Composition ranges for cleaning products of the present
invention. All percentages are weight percentages.

| Foam Layer | Second Layer | Adhesive | Other |
|---|---|---|---|
| 10% to 50% | 30% to 60% | 2% to 25% | |
| 50% to 90% | 8% to 40% | 5% to 30% | |
| 55% to 85% | 15% to 40% | 3% to 30% | |
| 55% to 80% | 15% to 40% | 3% to 25% | Filler: 0 to 8% |
| 55% to 80% | 15% to 40% | 3% to 25% | Filler: 1 to 10% |
| 10% to 50% | 30% to 60% | 2% to 25% | Surfactant: |
| | | | 0.2% to 5% |
| 10% to 50% | 30% to 60% | 2% to 25% | Skin care agent: |
| | | | 0.2% to 5% |
| 10% to 30% | 40% to 85% | 2% to 25% | Skin care agent: |
| | | | 0.5% to 10% |

Other approaches may be used to attach a second layer to the foam layer. For example, the second layer can be attached to the foam layer mechanically, as with, e.g., stitches. The second layer can be attached to the foam layer through inputting energy, as with, e.g., sonic energy, ultrasonic energy, or irradiative heat energy. Furthermore, the foam layer can be adapted to releasably attach to the remainder of the cleaning composite, as with, for example, a hook-and-loop fastening system. Also, one or more of these same approaches may be used to attach or connect the hand-engaging element, e.g. an elastomeric strap, to the remainder of the cleaning composite.

The present invention also provides for a cleaning product that is adapted to clean dirt from a surface. The cleaning product includes a melamine based foam layer or similar brittle foam that is configured for engaging a surface and cleaning the surface. Without wishing to be bound by theory, it is believed that the minute size of the solid fiber-like struts in the foam that define the cells of the foam (e.g., struts generally having a diameter on the order of 5 microns or less, or on the order of 2 microns or less), coupled with a general degree of deformability of the bulk foam, allows the solid material under mild pressure to readily fit into crevices and recesses on a surface that may be filled with dirt or grime. A relatively non-rounded shape of the struts of solid material that define the sides of the open cell foams may also enhance the cleaning efficacy of the material, providing a somewhat knife-like attack on deposits during scrubbing, as opposed to the more gentle abrasive effect one might expect from filaments having substantially cylindrical cross-sections. Further, the relatively hard nature of the solid material is believed to be effective in scraping out the dirt or grime as the foam is moved over the surface. Alternatively, some have speculated that the brittleness of the foam allows small particles with sharp edges to break off when moving in contact with a surface, and that the small particles so formed contribute to the degree of friction and cleaning provided by the foam. The presence of water is generally helpful in the cleaning process, though other chemicals or cleaning agents need not be present (but can be, if desired).

In another version of the invention, the second layer acts as a reinforcing web layer. The second layer, or reinforcing web layer, provides at least some degree of structural rigidity to the melamine-based foam layer. The web layer can also be substantially hydrophilic to assist in wiping and removal of excess water in use, or as a moistened source of water to be applied to the surface prior to scrubbing with the foam layer.

Principles for manufacturing melamine-based foam are well known. Melamine-based foams are currently manufactured by BASF (Ludwigshafen, Germany) under the BASOTECT® brand name. For example, BASOTECT® 2011, with a density of about 0.01 g/cm³, may be used. Blocks of melamine-based foam for cleaning are marketed by Procter & Gamble (Cincinnati, Ohio) under the MR. CLEAN® brand name, and under the CLEENPRO™ name by LEC, Inc. of Tokyo, Japan (several product executions are shown at http://www.users.bigpond.com/jmc.au/CLEENPRO/CLEENPRO-E.htm and http://www.users.bigpond.com/jmc.au/CLEENPRO/CLEENPRO%20Family-E.htm, both printed on Nov. 13, 2003). Melamine-based foam is also marketed for acoustic and thermal insulation by many companies such as American Micro Industries (Chambersburg, Pa.).

Principles for production of melamine-based foam are disclosed by H. Mahnke et al. in EP-B 071 671, published Dec. 17, 1979. According to EP-B 017 671, they are produced by foaming an aqueous solution or dispersion of a melamine-formaldehyde condensation product which comprises an emulsifier (e.g., metal alkyl sulfonates and metal alkylaryl sulfonates such as sodium dodecylbenzene sulfonate), an acidic curing agent, and a blowing agent, such as a C5-C7 hydrocarbon, and curing the melamine-formaldehyde condensate at an elevated temperature. The foams are reported to have the following range of properties:
a density according to DIN 53 420 between 4 and 80 grams per liter (g/l), corresponding to a range of 0.004 g/cc to 0.08 g/cc (though for purposes of the present invention the density can also range from about 0.006 g/cc to about 0.1 g/cc, or other useful ranges);
a thermal conductivity according to DIN 52 612 smaller than 0.06 W/m ° K;
a compression hardness according to DIN 53 577 under 60% penetration, divided by the density, yielding a quotient less than 0.3 (N/cm²)/(g/l), and preferably less than 0.2 (N/cm²)/(g/l), whereby after measurement of compression hardness the thickness of the foam recovers to at least 70% and preferably at least 90% of its original thickness;
an elasticity modulus according to DIN 53 423, divided by the density of the foam, under 0.25 (N/mm²)/(g/l) and preferably under 0.15 (N/mm²)/(g/l);
a bending path at rupture according to DIN 53 423 greater than 6 mm and preferably greater than 12 mm;
a tensile strength according to DIN 53 571 of at least 0.07 N/mm² or preferably at least 0.1 N/mm²; and
by German Standard Specification DIN 4102 they show at least standard flammability resistance and preferably show low flammability.

U.S. Pat. No. 6,503,615, issued Jan. 7, 2003 to Horii et al., discloses a wiping cleaner made from an open-celled foam such as a melamine-based foam, the wiping cleaner having a density of 5 to 50 kg/m3 in accordance with JIS K 6401, a tensile strength of 0.6 to 1.6 kg/cm2 in accordance with JIS K 6301, an elongation at break of 8 to 20% in accordance with JIS K 6301 and a cell number of 80 to 300 cells/25 mm as measured in accordance with JIS K 6402. Melamine-based foams having such mechanical properties can be used within the scope of the present invention.

Related foams are disclosed in U.S. Pat. No. 3,093,600 with agents present to improve the elasticity and tear strength of the foam.

Brittle foams can be made, as described in German publication DE-AS 12 97 331, from phenolic components, urea-based components, or melamine-based components, in aqueous solution with a blowing agent and a hardening catalyst.

The entire disclosure of U.S. Pat. No. 6,608,118 is incorporated by reference herein in its entirety.

Melamine-based foams are also disclosed in British patent GB 1443024, issued Jul. 21, 1976.

The brittle foam may comprise organic or inorganic filler particles, such as from 5% to 30% by weight of a particulate material. Exemplary particulate materials include clays such as kaolin, talc, calcium oxide, calcium carbonate, silica, alumina, zeolites, carbides, quartz, and the like. The fillers can also be fibrous materials, such as wood fibers, papermaking fibers, coconut fibers, milkweed fibers, flax, kenaf, sisal, bagasse, and the like. The particles of fibers added to the foam may be heterogeneously distributed or may be distributed homogeneously.

The foam or a portion thereof may also be impregnated with a material to reinforce or harden the foam, if desired, such as impregnation with water glass or other silicate compounds, as disclosed in U.S. Pat. No. 4,125,664, “Shaped Articles of Foam Plastics,” issued Nov. 14, 1978 to H. Giesemann, herein incorporated by reference. Adhesives, hot melts, cleaning agents, bleaching agents (e.g., peroxides), antimicrobials, and other additives may be impregnated in the foam.

The foam may be molded or shaped into three-dimensional shapes for aesthetic or functional purposes. For example, melamine-based foam may be thermally molded according to the process disclosed in U.S. Pat. No. 6,608,118, “Melamine Molded Foam, Process for Producing the Same, and Wiper,” issued Aug. 19, 2003 to Y. Kosaka et al., herein incorporated by reference, which discloses molding the foam at 210 to 350 C (or, more particularly, from 230° C. to 280° C. or from 240° C. to 270° C.) for 3 minutes or longer to cause plastic deformation under load, wherein the foam is compressed to a thickness of about 1/1.2 to about 1/12 the original thickness, or from about 1/1.5 to about 1/7 of the original thickness. The molded melamine foams can be joined to a urethane sponge layer to form a wipe, according to of Kosaka et al.

As described by Kosaka et al., the melamine-based foam can be produced by blending major starting materials of melamine and formaldehyde, or a precursor thereof, with a blowing agent, a catalyst and an emulsifier, injecting the resultant mixture into a mold, and applying or generating heat (e.g., by irradiation or electromagnetic energy) to cause foaming and curing. The molar ratio of melamine to formaldehyde (i.e., melamine:formaldehyde) for producing the precursor is said to be preferably 1:1.5 to 1:4, or more particularly 1:2 to 1:3. 5. The number average molecular weight of the precursor can be from about 200 to about 1,000, or from about 200 to about 400. Formalin, an aqueous solution of formaldehyde, can be used as a formaldehyde source.

As monomers for producing the precursor, according to Kosaka et al., the following monomers may be used in an amount of 50 parts by weight (hereinafter abbreviated as “parts”) or less, particularly 20 parts by weight or less, per 100 parts by weight of the sum of melamine and formaldehyde. Melamine is also known by the chemical name 2,4,6-triamino-1,3,5-triazine. As other monomers corresponding to melamine, there may be used C1-5 alkyl-substituted melamines such as methylolmelamine, methylmethylolmelamine and methylbutylolmelamine, urea, urethane, carbonic acid amides, dicyandiamide, guanidine, sulfurylamides, sulfonic acid amides, aliphatic amines, phenols and the derivatives thereof. As aldehydes, there may be used acetaldehyde, trimethylol acetaldehyde, acrolein, benzaldehyde, furfurol, glyoxal, phthalaldehyde, terephthalaldehyde, and the like.

As the blowing agent, there may be used pentane, trichlorofluoromethane, trichlorotrifluoroethane, etc. As the catalyst, by way of example, formic acid may be used and, as the emulsifier, anionic surfactants such as sodium sulfonate may be used.

The amount of the electromagnetic energy to be irradiated for accelerating the curing reaction of the reaction mixtures can be adjusted to be from about 500 to about 1,000 kW, or from about 600 to 800 kW, in electric power consumption based on 1 kg of an aqueous formaldehyde solution charged in the mold. If the electric power applied is insufficient, there may be insufficient foaming, leading to production of a cured product with a high density. On the other hand, in case when the electric power consumption is excessive, the pressure upon foaming becomes high, leading to significant exhaust flows from the mold and even the possibility of explosion.

Other useful methods for producing melamine-based foam are disclosed in U.S. Pat. No. 5,413,853, “Melamine Resin Foam,” issued May 9, 1995 to Y. Imashiro et al., herein incorporated by reference. According to Imashiro et al., a melamine resin foam can be obtained by coating a hydrophobic component on a known melamine-formaldehyde resin foam body obtained by foaming a resin composition composed mainly of a melamine-formaldehyde condensate and a blowing agent. The components used in the present melamine resin foam can therefore be the same as those conventionally used in production of melamine-formaldehyde resins or their foams, except for the hydrophobic component.

As an example, Imashiro et al. disclose a melamine-formaldehyde condensate obtained by mixing melamine, formalin and paraformaldehyde and reacting them in the presence of an alkali catalyst with heating. The mixing ratio of melamine and formaldehyde can be, for example, 1:3 in terms of molar ratio.

The melamine-formaldehyde condensate can have a viscosity of about 1,000-100,000 cP, more specifically 5,000-15,000 cP and can have a pH of 8-9.

As the blowing agent, a straight-chain alkyl hydrocarbon such as pentane or hexane is disclosed.

In order to obtain a homogeneous foam, the resin composition composed mainly of a melamine-formaldehyde condensate and a blowing agent may contain an emulsifier. Such an emulsifier includes, for example, metal alkylsulfonates and metal alkylarylsulfonates.

The resin composition may further contain a curing agent in order to cure the foamed resin composition. Such a curing agent includes, for example, acidic curing agents such as formic acid, hydrochloric acid, sulfuric acid and oxalic acid.

The foam disclosed by Imashiro et al. can be obtained by adding as necessary an emulsifier, a curing agent and further a filler, etc. to the resin composition composed mainly of a melamine-formaldehyde condensate and a blowing agent, heat-treating the resulting mixture at a temperature equal to or higher than the boiling point of the blowing agent to give rise to foaming, and curing the resulting foam.

In another embodiment, the foam material may comprise a melamine-based foam having an isocyanate component (isocyanate-based polymers are generally understood to include polyurethanes, polyureas, polyisocyanurates and mixtures thereof). Such foams can be made according to U.S. Pat. No. 5,436,278, “Melamine Resin Foam, Process for Production Thereof and Melamine/Formaldehyde Condensate,” issued Jul. 25, 1995 to Imashiro et al., herein incorporated by reference, which discloses a process for producing a melamine resin foam comprising a melamine/formaldehyde condensate, a blowing agent and an isocyanate. One embodiment includes the production of a melamine resin foam obtained by reacting melamine and formaldehyde in the presence of a silane coupling agent. The isocyanate used in U.S. Pat. No. 5,436,278 can be exemplified by CR 200 (a trademark of polymeric-4,4′-diphenylmethanediisocyanate, produced by Mitsui Toatsu Chemicals, Inc.) and Sumidur E211, E212 and L (trademarks of MDI type prepolymers, produced by Sumitomo Bayer Urethane Co., Ltd). One example therein comprises 100 parts by weight of melamine/formaldehyde condensate (76% concentration), 6.3 parts sodium dodecylbenzenesulfonate (30% concentration), 7.6 parts pentane, 9.5 parts ammonium chloride, 2.7 parts formic acid, and 7.6 parts CR 200. A mixture of these components was placed in a mold and foamed at 100° C., yielding a material with a density of 26.8 kg/m³ (0.0268 g/cm³), a compression stress of 0.23 kgf/cm², and a compression strain of 2.7%. In general, the melamine-based foams of U.S. Pat. No. 5,436,278 typically had a density of 25-100 kg/m³, a compression strain by JIS K 7220 of 2.7%-4.2% (this is said to be improved by about 40%-130% over the 1.9% value of conventional fragile melamine foams), and a thermal conductivity measured between 10° C. to 55° C. of 0.005 kcal/m-h-° C. or less (this is far smaller than 0.01 kcal/m-h-° C. which is said to be the value of conventional fragile foam). Other foams comprising melamine and isocyanates are disclosed in WO 99/23160, “Composition and Method for Insulating Foam,” published May 14, 1999 by Sufi, the U.S. equivalent of which (application U.S. Pat. No. 9,823,864) is herein incorporated by reference.

In another embodiment, a melamine-based foam may be used that is produced according to WO 0/226872, “Hydrophilic, Open-Cell, Elastic Foams with a Melamine/Formaldehyde Resin Base, Production Thereof and use thereof in Hygiene Products,” published Apr. 4, 2002 by Baumgartl and Herfert. Such foams have been tempered at elevated temperature to improve their suitability for use as absorbent articles in proximity to the human body. During or after the tempering process, further treatment with at least one polymer is disclosed, the polymer containing primary and/or secondary amino groups and having a molar mass of at least 300, although this polymer treatment may be skipped, if desired, when the foams of WO 0/226872 are applied to the present invention. Such foams are said to have a specific surface area determined by BET of at least 0.5 m²/g. Exemplary phenolic foams include the dry floral foams made by Oasis Floral Products (Kent, Ohio) and also the water-absorbent open-celled brittle phenolic foams manufactured by Aspac Floral Foam Company Ltd. (Kowloon, HongKong), partially described at http://www.aspachk.com/v9/asac/why aspac.html. Open-cell phenolic foams can be made from the phenolic resins of PA Resins (Malmö, Sweden) combined with suitable hardeners (e.g., an organic sulfonic acid) and emulsifiers with a blowing agent such as pentane. Phenolic resins may include resole resins or novolac resins, for example, such as the Bakelite® Resin 1743 PS (Bakelite AG, Iserlohn-Letmathe, Germany) which is used for floral foams.

### BRIEF DESCRIPTION OF THE DRAWINGS

FIG. 1 is a perspective view of one representative version of a cleaning composite of the present invention.

FIG. 2 is a perspective view of another representative version of a cleaning composite of the present invention.

FIG. 3 is a perspective view of another representative version of a cleaning composite of the present invention.

### DEFINITIONS

Within the context of this specification, each term or phrase below includes the following meaning or meanings:

“Attach” and its derivatives refer to the joining, adhering, connecting, bonding, sewing together, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Bond” and its derivatives refer to the joining, adhering, connecting, attaching, sewing together, or the like, of two elements. Two elements will be considered to be bonded together when they are bonded directly to one another or indirectly to one another, such as when each is directly bonded to intermediate elements. “Bond” and its derivatives include permanent, releasable, or refastenable bonding.

“Coform” refers to a blend of meltblown fibers and absorbent fibers such as cellulosic fibers that can be formed by air forming a meltblown polymer material while simultaneously blowing air-suspended fibers into the stream of meltblown fibers. The coform material may also include other materials, such as superabsorbent materials. The meltblown fibers and absorbent fibers are collected on a forming surface, such as provided by a foraminous belt. The forming surface may include a gas-pervious material that has been placed onto the forming surface.

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

“Disposable” refers to articles that are designed to be discarded after a limited use rather than being laundered or otherwise restored for reuse.

The terms “disposed on,” “disposed along,” “disposed with,” or “disposed toward” and variations thereof are intended to mean that one element can be integral with another element, or that one element can be a separate structure bonded to or placed with or placed near another element.

“Elastic,” “elasticized,” “elasticity,” and “elastomeric” mean that property of a material or composite by virtue of which it tends to recover its original size and shape after removal of a force causing a deformation. Suitably, an elastic material or composite can be elongated by at least 25 percent (to 125 percent) of its relaxed length and will recover, upon release of the applied force, at least 40 percent of its elongation.

“Extensible” refers to a material or composite that is capable of extension or deformation without breaking, but does not substantially recover its original size and shape after removal of a force causing the extension or deformation. Suitably, an extensible material or composite can be elongated by at least 25 percent (to 125 percent) of its relaxed length.

“Fiber” refers to a continuous or discontinuous member having a high ratio of length to diameter or width. Thus, a fiber may be a filament, a thread, a strand, a yarn, or any other member or combination of these members.

“Film” refers to a thermoplastic film made using a film extrusion and/or foaming process, such as a cast film or blown film extrusion process. The term includes apertured films, slit films, and other porous films that constitute liquid transfer films, as well as films that do not transfer liquid.

“Hydrophilic” describes fibers or the surfaces of fibers that are wetted by aqueous liquids in contact with the fibers. The degree of wetting of the materials can, in turn, be described in terms of the contact angles and the surface tensions of the liquids and materials involved. Equipment and techniques suitable for measuring the wettability of particular fiber materials or blends of fiber materials can be provided by a Cahn SFA-222 Surface Force Analyzer System, or a substantially equivalent system. When measured with this system, fibers having contact angles less than 90 degrees are designated “wettable” or hydrophilic, and fibers having contact angles greater than 90 degrees are designated “nonwettable” or hydrophobic.

“Layer” when used in the singular can have the dual meaning of a single element or a plurality of elements.

“Liquid impermeable,” when used in describing a layer or multi-layer laminate means that liquid, such as urine, will not pass through the layer or laminate, under ordinary use conditions, in a direction generally perpendicular to the plane of the layer or laminate at the point of liquid contact.

“Liquid permeable” refers to any material that is not liquid impermeable.

“Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and 40 microns), and microfibers (with average diameters less than about 10 microns). Meltblowing processes are particularly suited to making microfibers, including ultra-fine microfibers (with an average diameter of about 3 microns or less). A description of an exemplary process of making ultra-fine microfibers may be found in, for example, U.S. Pat. No. 5,213,881 to Timmons, et al. Meltblown fibers may be continuous or discontinuous and are generally self bonding when deposited onto a collecting surface.

“Member” when used in the singular can have the dual meaning of a single element or a plurality of elements.

“Nonwoven” and “nonwoven web” refer to materials and webs of material that are formed without the aid of a textile weaving or knitting process. For example, nonwoven materials, fabrics or webs have been formed from many processes such as, for example, meltblowing processes, spunbonding processes, air laying processes, and bonded carded web processes.

“Stretchable” means that a material can be stretched, without breaking, by at least 25 percent (to 125 percent of its initial (unstretched) length) in at least one direction. Elastic materials and extensible materials are each stretchable materials.

“Stretch-bonded” refers to a composite material having at least two layers in which one layer is a gatherable layer and the other layer is an elastic layer. The layers are joined together when the elastic layer is in an extended condition so that upon relaxing the layers, the gatherable layer is gathered. For example, one elastic member can be bonded to another member while the elastic member is extended at least about 25 percent of its relaxed length. Such a multilayer composite elastic material may be stretched until the nonelastic layer is fully extended. One type of stretch-bonded laminate is disclosed, for example, in U.S. Pat. No. 4,720,415 to Vander Wielen et al., which is incorporated herein by reference. Other composite elastic materials are described and disclosed in U.S. Pat. No. 4,789,699 to Kieffer et al., U.S. Pat. No. 4,781,966 to Taylor, U.S. Pat. No. 4,657,802 to Morman, and U.S. Pat. No. 4,655,760 to Morman et al., all of which are incorporated herein by reference thereto.

These terms may be defined with additional language in the remaining portions of the specification.

### DETAILED DESCRIPTION

Reference will now be made in detail to embodiments of the invention, one or more examples of which are illustrated in the drawings. Each example is provided by way of explanation of the invention, and is not meant as a limitation of the invention. For example, features illustrated or described as part of one embodiment can be used with another embodiment to yield still a third embodiment. It is intended that the present invention include these and other modifications and variations.

It is to be understood that the ranges and limits mentioned herein include all ranges located within, and also all values located under or above the prescribed limits. For instance, a range from about 100 to 200 also includes ranges from 110 to 150, 170 to 190, and 153 to 162. Further, a limit of up to about 7 also includes a limit of up to about 5, up to 3, and up to about 4.5.

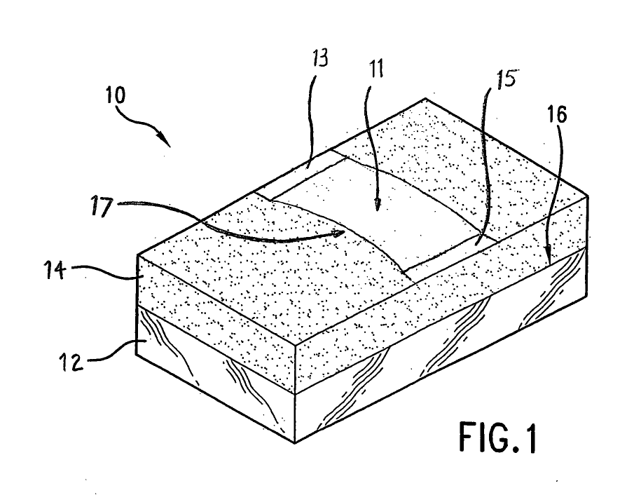

The present invention provides for a cleaning product which may be a cleaning composite 10 as shown in FIG. 1. The cleaning composite 10 includes a foam 12 such as a melamine-based foam that is attached to a second layer, or web 14. The foam 12 generally has an open celled structure that when moved over a surface is capable of effectively cleaning dirt and other unwanted elements from the surface. The second layer 14 may act as a reinforcing layer in order to strengthen or hold the melamine based foam 12, and/or may provide for water retaining properties which help to keep the melamine based foam 12 wet should wet wiping with the cleaning composite 10 be conducted. Alternatively or in addition, the second layer 14 may be adapted for scrubbing, and may comprise abrasive material (not shown) such as coarse polymeric filaments, meltblown shot, abrasive particles, hook-like protrusions such as those used in hook and loop mechanical fastening systems, and the like. The second layer 14 may have a coefficient of friction relative to human skin such that the palm-side surface of a hand, when resting on the second layer, will not readily slip when the cleaning composite is used.

An element 11 adapted to engage the hand, in this exemplary embodiment an elastomeric strap, is attached at two locations 13 and 15 along the length of the element so that a user's hand, or some portion of a user's hand, may be placed under the element and through the opening 17 (the opening 17 is between element 11 and the surface of second layer 14). In some embodiments, element 11 is attached to the remainder of the cleaning composite 10 in more than two locations. For example, element 11 can be attached to the remainder of cleaning composite 10 at five different locations along the length of element 11, thus creating four openings, one for each finger of a user's hand. Or element 11 can be attached to the remainder of cleaning composite 10 at six different locations along the length of element 11, thus creating five openings, one for each finger of a user's hand, and one for the user's thumb. Any number of openings may be created by attaching element 11 to the remainder of the cleaning composite, so long as the openings facilitate use of the cleaning composite as described herein.

It should be noted that attachment of element 11 to the remainder of cleaning composite 10 is not restricted to the depicted orientation; i.e., so that the ends of element 11 are flush with the sides of the remainder of the cleaning composite 10. Instead, element 11 can be attached so that the ends of element 11 are attached inward of a side or perimeter of the remainder of cleaning composite 10. Furthermore, the sides of element 11 need not be parallel and/or perpendicular to the sides of the remainder of the cleaning composite. For example, element 11 may be attached so that its sides are at some obtuse or acute angle relative to the sides of the remainder of the cleaning composite 10 (e.g., as with a diagonal placement of element 11 relative to the orientation of the remainder of the cleaning composite 10). Alternatively, element 11 can be attached so that it generally traces an arcuate path along the surface of the remainder of composite 10. Again, any orientation of element 11 relative to the remainder of the cleaning composite is acceptable so long as the hand-engaging element facilitates use of the composite as described herein.

While the exemplary embodiment in FIG. 1 shows element 11 as being attached at the surface of second layer 14, the present invention is not restricted to this version. Element 11 may also be attached to: the sides of the cleaning composite; the surface of foam layer 12; and between foam layer 12 and second layer 14.

FIG. 1 depicts cleaning composite 10 as possessing a generally rectangular shape. As is noted below, a cleaning composite of the present invention may possess a variety of shapes, including, for example, a generally square shape or a generally oval shape.

While the exemplary embodiment in FIG. 1 depicts a planar surface on second layer 14 (i.e., the layer which, in this particular embodiment, will contact a user's hand during use of cleaning composite 10), it should be noted that one or both surfaces of cleaning composite 10 may be contoured. In some versions of the invention, a surface may be contoured in such a way that the resulting surface is adapted to better conform to the palm-side surface of a user's hand.

In some versions of the invention, element 11 may be positioned by a user such that opening 17, which, in the exemplary version depicted in FIG. 1, is between element 11 and the surface of second layer 14, is instead between element 11 and the surface of foam layer 12. For example, if element 11 is selected so that it is sufficiently elastomeric, a user could stretch element 11 so that the unattached portion of element 11 is re-positioned so that it is in facing relation to the surface of foam layer 12; i.e., the user can choose to move element 11 such that opening 17 is either between element 11 and the surface of second layer 14; or between element 11 and the surface of foam layer 12. Some versions of the invention may be better suited to facilitate this particular feature. For example, attaching element 11 to the sides of the remainder of cleaning composite 10, or between foam layer 12 and second layer 14, may better facilitate a user's positioning of element 11 either in facing relation to the foam layer 12 (i.e., opening 17 is between element 11 and foam layer 12), or in facing relation to second layer 14 (i.e., opening 17 is between element 11 and second layer 14).

Embodiments described in the preceding paragraph facilitate use of those versions of the invention in which a user may select either foam layer 12 or second layer 14 for cleaning and/or treating a surface. So, for example, if a user wished to clean and/or treat a surface using foam layer 12, he or she would position element 11 so that opening 17 was between element 11 and second layer 14. Alternatively, if a user wished to clean and/or treat a surface using second layer 14, he or she would position element 11 so that opening 17 was between element 11 and foam layer 12.

In some versions of the invention, the cleaning composite may comprise a plurality of hand-engaging elements. For example, two hand-engaging elements could be positioned such that one element is attached to the remainder of the cleaning composite to form an opening adapted to receive the thumb of a user's hand, while another hand-engaging element is positioned such that the element is attached to the remainder of the cleaning composite to form an opening adapted to receive the remaining portion of a user's hand (i.e., around a user's four fingers). Any number of individual hand-engaging elements may be attached to the remainder of cleaning composite 10 (and, as described above, at different orientations relative to cleaning composite 10), so long as the selected number of hand-engaging elements, and their orientations, facilitate use of the cleaning composite as described herein.

The relative thicknesses of the layers depicted in the exemplary embodiment of FIG. 1 can vary. Foam layer 12 and second layer 14 may be of approximately the same thickness. Alternatively second layer 14 may be less thick than foam layer 14, perhaps substantially so. In some versions of the invention, foam layer 12 may be less thick than second layer 14.

Note, too, that in some versions of the invention, there is no second layer 14. Instead, element 11 is attached directly to the foam layer.

As discussed above, to the extent a second layer is present, it may be flexible, semi-rigid, or rigid.

While the interface 16 between foam layer 12 and second layer 14 in FIG. 1 is depicted as planar, the present invention is not restricted to such planar interfaces. For example, interface 16 could trace a sinusoidal wave pattern, as with an undulating surface of a foam layer adapted to fit with a complementary undulating surface of a second layer. The interface between the two layers may be of other shapes.

The hand-engaging element 11 may help reduce fatigue of a user of the cleaning composite in that a user of the present invention likely will not have to grip the composite as firmly as cleaning products that lack a hand-engaging element 11. Furthermore, the element may help to reduce the chance that the cleaning composite is dropped during use. Also, the hand-engaging element 11 may improve the effectiveness of the cleaning composite because the composite is less likely to slip against the palm-side surface of the hand during use. As stated above, the chance of such slippage can be further reduced by selecting a second layer 14 having a coefficient of friction relative to human skin such that the palm-side surface of a hand, when resting on the second layer, will not readily slip when the cleaning composite is being used.

The second layer or web 14 may comprise a structure of fibers or filaments that are retained to one another by fiber-fiber bonding (e.g., hydrogen bonding), fiber entanglement, adhesive bonding, interfiber or interfilament friction, and the like. In accordance with one exemplary embodiment of the present invention, the second layer 14 can be a hydrophilic cellulosic fibrous web such as a wet-laid or air-laid paper web comprising predominately natural cellulosic fibers such as wood-based papermaking fibers, cotton, kenaf, bagasse, milkweed, etc., and mixtures thereof. In other embodiments, the web may be a paper web comprising synthetic cellulosic fibers such as rayon. Alternatively, the second layer 14 can be a nonwoven fibrous web which has a structure of individual fibers or threads which are interlaid, but not in an identifiable manner as in a knitted fabric. The fibers in a nonwoven web are generally understood to be manmade fibers such as non-cellulosic polymeric fibers, typically based on synthetic polymers such as polyolefins, including webs made from meltspun processes (meltblowing, spinbonding, etc.). Alternatively, the second layer 14 need not include a fiber structure but may be, for instance, a film or foam, or plastic.

As shown in FIG. 1, the cleaning composite 10 includes a single layer of melamine based foam or another cleaning foam attached to a second layer shown as second layer 14. Alternative exemplary embodiments exist in which the foam 12 and/or second layer 14 are made of any number of layers. The foam 12 may be laminated to second layer 14 in order to effect attachment of these two components of the cleaning composite 10. The term “laminated” as used herein means the two components are united to one another by an adhesive, optionally with the use of heat and/or pressure. However, in accordance with other exemplary embodiments of the present invention, the foam 12 may be attached to the second layer 14 in a variety of manners. For instance, these two components may be attached to one another by ultrasonic bonding, hot melts/adhesives, pressure sensitive adhesives, thermal bonds, or by mechanical attachments such as sewing, mechanical fasteners, or a hook-and-loop-type fastener (e.g., systems comprising VELCRO®-type materials) in accordance with other exemplary embodiments. Hydroentangling can also be used to join a fibrous web to the foam. In one embodiment, a hotmelt adhesive is used comprising at least one polymer with a substantial number of carboxyl groups or salts thereof to provide good bonding with a fibrous cellulosic web when wet. For example, a hot melt adhesive suitable for the present invention may comprise ethylene vinyl acetate (EVA), and may have at least about 20 weight percent (wt %) EVA or at least about 50 wt % EVA. Hotmelt adhesives may be applied by meltblown nozzles, glue guns, other known adhesive nozzles, and the like. After the hotmelt adhesive is applied to one or both surfaces to be joined, the two surfaces can immediately be brought into contact and optionally pressed together with a compressive force, such as a force of about 0.03 psi or greater, or about 0.5 psi or greater, or about 5 psi or greater. The compressive force may be provided by a nip between two rollers, pressure between two flat plates, or other methods known in the art.

The cleaning composite 10 may be configured such that the foam 12 is a relatively thin layer. For instance, the foam may be on the order of from about 2 millimeters to about 8 millimeters in thickness. Other exemplary embodiments of the present invention exists in which the foam 12 may have a varying thickness, for instance being 1 millimeter thick at certain portions of the second layer 14, and being 10 millimeters thick at other portions of the second layer 14. As such, the present invention includes various embodiments in which the foam 12 has a uniform thickness throughout, and also a varying thickness throughout. Additionally, the present invention includes exemplary embodiments where the foam 12 is less than 60 millimeters in thickness. In other versions, the thickness of the foam 12 is less than 50 millimeters in thickness. In still other versions, the thickness of the foam 12 is less than 40 millimeters in thickness. In other exemplary embodiments the thickness of the foam 12 is less than 30 millimeters in thickness. Other exemplary versions of the foam 12 have a thickness less than 20 millimeters in thickness. Still further exemplary embodiments exist in which the foam 12 is less than 15 millimeters in thickness, less than 10 millimeters in thickness, and less than 5 millimeters in thickness. Additional exemplary embodiments of the present invention exist in which the foam 12 is from about 1 millimeter to about 15 millimeters in thickness.

The foam 12 may be free from plastic deformation. In another aspect, the melamine based foam 12 used in the present application may be capable of regaining a part of or all of its original shape and size after being subjected to some degree of deformation.

The lamination of the foam 12 to the second layer 14 may be done with the aid of hot melt adhesives in accordance with certain exemplary embodiments of the present invention.

As stated above, second layer 14 may have a flexibility of any degree. For instance, the second layer 14 may be fairly flexible or may be relatively rigid. The second layer 14 may have the same flexibility as the foam 12 to which it is attached, or may have a flexibility that is greater than or less than the foam 12 attached thereto.

The second layer 14 may be made of a soft material so that it is capable of buffing or polishing a surface. Alternatively, the second layer 14 may be made of a coarse material such that the second layer 14 is more coarse or abrasive than the foam 12. In this instance, the cleaning composite 10 may be used so that the second layer 14 is capable of scrubbing coarse surfaces which would otherwise damage the foam 12. In fact, the second layer 14 may be more capable of removing dried food substances or ground in dirt and some other unwanted elements from a surface to be cleaned in other exemplary embodiments. The second layer 14 may comprise abrasive grit or meltblown shot joined to a fibrous substrate, or abrasive fibers such as the multifilamentary aggregates disclosed in commonly owned U.S. patent application Ser. No. 10/321,831, “Meltblown Scrubbing Product,” filed Dec. 17, 2002 by Chen et al., herein incorporated by reference. A portion of the cleaning surface of the foam 12 may also be joined to materials such as meltblown shot or multifilamentary aggregates, in order to enhance cleaning or to strengthen the foam 12 and prevent the foam 12 from being damaged during cleaning.

In certain exemplary embodiments of the present invention, the second layer 14 may be configured so that it can help provide water to the foam 12 during cleaning, should the cleaning composite 10 be configured as a wet cleaning composite and be used in a wet state during cleaning. The second layer 14 in addition to, or alternatively to, helping provide water to the foam 12 may also be used in order to wipe away particulates that are created by the foam 12. These particulates are essentially tiny portions of the foam 12 that may be broken away during movement of the foam 12 across the surface that is being cleaned. Additionally, the particulates that are removed by the second layer 14 may also be particles of dirt or other unwanted objects that are detached from the surface by the foam 12.

Element 11 is adapted to engage the hand. It may be made of any of the materials available to construct second layer 14. The selected material should be such that element 11 has sufficient integrity to withstand various forces acting on the cleaning composite and element 11 during use of the composite. Thus, for example, an elastomeric web comprising individual elastic strands, such as LYCRA®, that are sandwiched between, and intermittently attached to, two nonwoven layers may be used to form element 11. Examples of such elastomeric webs are disclosed in U.S. patent application Ser. No. 954,400 entitled “Absorbent Article With Enhanced Elastic Design For Improved Aesthetics And Containment” by R. St. Louis et al. and filed Oct. 20, 1997 (attorney docket no. 13,346), now U.S. Pat. No. 5,993,433 granted Nov. 30, 1999; and in U.S. patent application Ser. No. 09/327,368 entitled “Absorbent Article With More Conformable Elastics” by M. Beitz et al. and filed Jun. 4, 1999 (attorney docket no. 14,188), now U.S. Pat. No. 6,248,097 granted Jun. 19, 2001, which are incorporated by reference in their entirety in a manner consistent herewith. In particular embodiments, the elastic material of the hand-engaging element comprises a stretch-thermal laminate (STL), a neck-bonded laminated (NBL), a reversibly necked laminate, or a stretch-bonded laminate (“SBL”) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; and European Patent Application No. EP 0 217 032 published on Apr. 8, 1987 in the names of Taylor et al.; all of which are incorporated herein by reference

In some versions of the present invention, element 11 is adapted to be adjustable. For example, rather than element 11 being a single unitary piece, element 11 could comprise two elements or pieces that releasably engage one another. Such versions of the invention are discussed in more detail below.

Element 11 may be attached to the remainder of the cleaning composite using any of the methods of attachment used to attach the second layer 14 to the foam layer 12. It should be noted that element 11, in some versions of the invention, may be a continuous loop of material. This loop could be attached, at a single location on the loop, to the foam layer 12 or the second layer 14. Alternatively, the loop could be attached at two or more locations along its perimeter to the foam layer 12, or the second layer 14. For purposes of this application, the “length” of an element 11 that is a continuous loop is the loop's perimeter.

In other versions, element 11 may be a unitary piece, comprising components adapted to releasably engage one another (as discussed herein), that is attached at a single location along its length to the remainder of the cleaning composite (e.g., the end of an elastomeric strap could be attached to the remainder of the cleaning composite). A portion of element 11 that freely extends from this point of attachment may be directed through an aperture, hole, or slit in the cleaning composite. That portion of element 11 that passes through the aperture, hole, or slit can then be folded or looped back, and releasably engaged to, that portion of element 11 that is not passed through the aperture, hole, or slit. The components of element 11 that are adapted to releasably engage one another may be positioned, and their size selected, so that a user can adjust the size of opening 17 (for improved fit for that particular user's hand).

Furthermore, rather than have an aperture, hole, or slit in the cleaning composite, a separate component comprising an aperture, hole, or slit could be attached to the cleaning composite. In this version of the invention, element 11, again as a unitary piece comprising components adapted to releasably engage one another (as discussed herein), is attached at a single location along its length to the remainder of the cleaning composite (e.g., the end of an elastomeric strap could be attached to the remainder of the cleaning composite). A portion of element 11 that freely extends from this point of attachment may be directed through the separate component comprising an aperture, hole, or slit in the cleaning composite. That portion of element 11 that passes through the aperture, hole, or slit can then be folded or looped back, and releasably engaged to, that portion of element 11 that is not passed through the aperture, hole, or slit. The components of element 11 that are adapted to releasably engage one another may be positioned, and their size selected, so that a user can adjust the size of opening 17 (for improved fit for that particular user's hand).

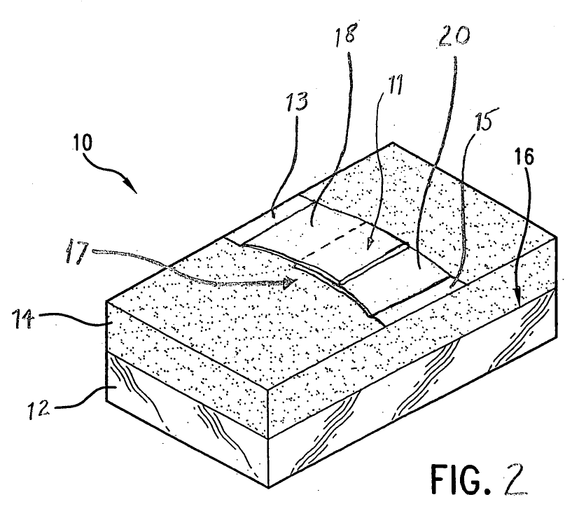

FIG. 2 shows another exemplary embodiment of a cleaning composite 10 in accordance with the present invention. Element 11 is made up of two separate pieces, designated in FIG. 2 as piece 18 and piece 20. Each of these pieces is attached to the remainder of cleaning composite 10 at some location along each of their respective lengths (as depicted in FIG. 2, these locations are locations 13 and 15). These pieces are adapted to releasably engage one another. In the exemplary embodiment, pieces 18 and 20 are depicted as overlapping, and engaging, one another. Any approach for releasably attaching these pieces may be used, so long as the selected approach is able to generally withstand forces that may act on element 11 and the remainder of cleaning composite 10 during conventional use of said composite. For example, one of pieces 18 and 20 may comprise hook material, with the other piece comprising loop material. When a user positions pieces 18 and 20 such that they overlap, he or she may press the pieces together such that some portion of the hook material on one piece engages, and becomes attached to, the loop material on the other piece. The respective areas of the loop material and hook material may be selected such that a user can adjust the size of opening 17 (for improved fit for that particular user's hand) (i.e., the user can choose various degrees of overlap between pieces 18 and 20 before releasably engaging the two pieces to one another.)

As stated above, other approaches may be used to releasably attach pieces 18 and 20 to one another. For example, each of pieces 18 and 20 can comprise cohesive or adhesive materials such that the pieces may be pressed together, and attached, to one another. Or other mechanical fasteners, such as snaps or buttons, could be used.

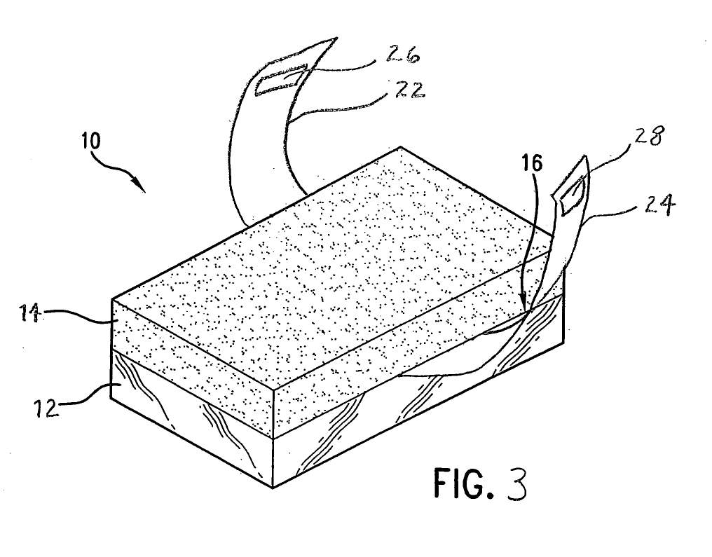

FIG. 3 depicts yet another exemplary embodiment. In this embodiment, the hand-engaging element comprises two pieces 22 and 24. A portion of each of these pieces is attached to the remainder of cleaning composite 10. In this instance, one end of each of pieces 22 and 24 is attached at the interface between foam layer 12 and second layer 14. Components of the pieces designed to releasably engage one another are depicted as components 26 and 28, respectively. The nature of these components can be selected such that a user can adjust the degree of overlap between pieces 22 and 24 (such that the opening formed between the engaged pieces and the surface of second layer 14 is adjustable in size, and therefore able to accommodate a variety of users' hand sizes).

It should be noted that pieces 18 and 20, in FIG. 2, and pieces 22 and 24, in FIG. 3, may be made from the same variety of materials as a unitary hand-engaging element, such as that depicted in FIG. 1. So, for example, one or both of pieces 18 and 20, and 22 and 24, may be made of an elastomeric material.

Note also that the exemplary embodiment in FIG. 3, and analogous embodiments, are suited to a user engaging the pieces either in facing relation to the surface of the second layer 14, thereby creating an opening for the user's hand between the engaged pieces 22 and 24 (i.e., the hand-engaging element) and second layer 14; or in facing relation to the surface of foam layer 12, thereby creating an opening for the user's hand between the engaged pieces 22 and 24 (i.e., the hand-engaging element) and foam layer 12.

Returning to FIG. 1, the foam 12 extends across the entire receiving surface (or interface) 16 of the second layer 14. In accordance with other exemplary embodiments, the foam 12 may extend only over a portion of the receiving surface 16 of the second layer 14. In some versions of the cleaning composite, foam 12 is provided with a visual indicating portion which is a portion of the foam 12 that is of a different color than the rest of the foam 12. For instance, the visual indicating portion may be red, while the rest of the foam 12 is white. Once a user has used a cleaning composite 10 to such a degree that a cavity is formed in the foam layer which extends into the visual indicating portion of the foam 12, the user will be provided with a visual indication that the cleaning wipe 10 is becoming worn. In this instance, the visual indicating portion may indicate to the user that the cleaning wipe 10 has reached its useful life and may be discarded. Alternatively, the visual indicating portion may indicate to the user that the cleaning wipe 10 has been used to such a degree that only a limited amount of life remains in the cleaning wipe 10 before it must be discarded.

In a related embodiment (not shown), a colored layer of material other than foam is disposed between the foam layer and the second layer to provide a visual indicator of wear. The colored layer may be an apertured or unapertured film, a nonwoven web, a paper layer, and the like, or may comprise colored adhesive that joins the fibrous web to the foam. Alternatively, the colored layer may be a part of the fibrous web, such as a layer comprising dyed fibers, or the entire web itself may be colored.

In accordance with one exemplary embodiment of the present invention, the foam layer 12 and the second layer 14 are attached to one another due to the fact that the foam 12 and the second layer 14 are integrally formed with one another. The foam 12 may be integrally formed with the plurality of fibers 20, which form the second layer 14 of the cleaning composite by a method as set forth in U.S. Pat. No. 6,603,054, which is owned by the assignee of the present invention and is incorporated herein for all purposes in its entirety. In one such instance, the second layer 14 may be dispersed throughout the foam 12 and therefore integrally connected therewith. Here, about 10% or more of the weight of the cleaning composite 10 may be from the plurality of fibers which are formed by blending loose fibers into a resin coupled with a blowing agent or other foam-producing means prior to curing the resin in order to form the foam.

In accordance with other exemplary embodiments of the present invention, the second layer 14 may be a scrim layer, a mesh, and/or an elastomeric network that is embedded in foam resin prior to curing in order to form a cleaning composite 10 that has a foam 12 integrally formed with the second layer 14. Various materials may be imbedded into the foam resin which is used to form the foam 12. For example, tow, woven fabrics, tissue layers, coform materials, nonwoven webs, milkweed fibers and natural or synthetic fibers may be used in order to form the second layer 14 of the present invention.

As stated above, the second layer 14 of the cleaning composite 10 may be used in order to act as a reinforcing layer to the foam 12, and/or may be configured in order to help clean the surface that is being cleaned by the cleaning composite 10, or both. The second layer 14 may in other exemplary embodiments of the present invention be provided with an additional functionality. In one version of the cleaning composite 10, second layer 14 is provided with a plurality of functional members disposed therein. The functional members may be cleaning agents in order to help aid the cleaning composite 10 in cleaning a surface. For instance, the functional members may be enzymes such as papain enzymes, or may be bleaching agents such as peroxide. Additionally, the functional members may be abrasive compounds or may be detergents in accordance with other exemplary embodiments. The functional members may also be configured such that they release an odor which may subsequently be transferred to the surface which is to be cleaned. Further, the functional members may be skin wellness agents. The functional members may be encapsulated in a polymeric or lipid shell capable of breaking during use in response to mechanical compression and shear, whereby ingredients in the functional members are released. Alternatively, the functional members may be encased or encapsulated in a water soluble material such that salvation of the material when wet permits release of the functional components. The functional members may be antimicrobial agents and/or natural plant based extracts or compounds in accordance with other exemplary embodiments.

The second layer 14 may also have an added functionality such that the second layer 14 and/or the functional members act as a biosensor. In this instance, should the second layer 14 and/or the functional members detect the presence of harmful bacteria, lead, mercury, or other agents, the second layer 14 and/or functional member may change color in order to indicate the presence of such agents. Alternatively or additionally, the second layer 14 and/or functional members may be heat generating agents, for instance the cleaning composite 10 may employ thermal pad technology. In one instance, oxidation of iron may result in a heating of the second layer 14. Alternatively, water activated technology may be used, such as calcium chloride pellets, in order to heat the second layer 14 such that the cleaning composite 10 is also heated. Heating of the cleaning composite 10 may be advantageous in that more effective cleaning of grease or other elements may be realized when employing the cleaning composite 10.

The functional members may be odor control agents such as cyclodextrins, zeolites, clays, and/or activated carbon particles or fibers. The cleaning composite 10 may also be configured to have a chemical agent in order to combat odor or to regulate the release of odor eliminating or odor providing compounds. Chemical agents which may be included are, for instance, chlorine dioxide, antimicrobial gases or liquids, time release antimicrobial compounds, silver ions embedded in the foam 12, zeolites, and/or chitosan-related compounds.

The second layer 14 and/or functional members disposed therein may also be foaming agents. In these instances, the foaming agents may be activated when contacted by water in order to create a foam which may additionally be used in helping the cleaning composite 10 clean a surface of dirt or other unwanted elements. Also, the functional members and/or the second layer 14 may be made of a material or configured in order to help keep the foam 12 wet during use of the cleaning composite 10.

Although described as being incorporated into the second layer 14, the functional members may be incorporated into the foam of the cleaning composite 10 in accordance with other various embodiments. Further, the functional members may be on the outer surface, edges, or even separate from the second layer 14 and/or foam 12.

As noted above, it is to be understood that the cleaning composite 10 of the present invention is not limited to a particular shape. As such, the cleaning composite 10 may be square, round, or cylindrical in accordance with various exemplary embodiments. Further, the cleaning composite 10 may have hollow elements that are configured in order to receive fingers, hands, cleaning agents, or inserts in accordance with various exemplary embodiments of the present invention.

The cleaning composite 10 may also be configured in some embodiments such that the “melamine based foam” is a non-melamine foam that contains melamine powder. Other representative embodiments that may be used in conjunction with a hand-engaging element are disclosed in U.S. patent application Ser. No. 10/744,238, filed on Dec. 22, 2003, and entitled “Multi Purpose Cleaning Product Including a Foam and a Web,” which is hereby incorporated by reference in its entirety in a manner consistent herewith.

### EXAMPLE

A prototype was made using the following procedure:
1. A melamine foam piece, product code RT-C1308, was obtained from Rock Tone Enterprise Co., Ltd., a business having offices in Taiwan. Hydroknit® material, product code X-80/X60, available from Kimberly-Clark Corporation, a business having offices in Neenah, Wis., was also obtained (Hydroknit®, is a nonwoven composite fabric that contains about 70% by weight pulp fibers that are hydraulically entangled into a continuous filament material). Both the melamine foam piece and the Hydroknit® material were die cut using a die # 00848 (oval shaped 5-⅛″×3-⅝″) to obtain oval shapes of like dimension (i.e., 5-⅛″×3-⅝″).
2. A stretch-bond laminate, or “SBL material” (i.e., an elastomeric material) was cut to make a strap 2″ wide and 3 and ⅝″ long.
3. The strap was placed in the center of the Hydroknit® material so that the ends of the length dimension of the strap (i.e., the dimension corresponding to a length of 3 and ⅝ inches) were approximately flush with the sides of the width dimension of the oval (i.e., dimension corresponding to a width of 3 and ⅝ inches). The strap was place such that sides of the width dimension of the strap (i.e., the dimension corresponding to a width of 2 inches) were each approximately 1.5 inches from the opposing tops of the oval-shaped ends.
4. using a straight stitch, white thread available from Coast & Clark America was used to stitch the SBL strap to the Hydroknit® layer.
5. DAP 100% silicone rubber sealant, made by Dow Corning and marketed by DAP Inc., was used to attach the Hydroknit® layer/SBL composite to the melamine foam piece. The adhesive was applied uniformly over one of the major surfaces of the melamine foam piece, and then the Hydroknit®/SBL composite was adhered to the melamine foam piece so that the perimeters of the two layers (i.e., the Hydroknit®/SBL composite and the melamine foam piece) were flush. The Hydroknit®/SBL composite was adhered to the melamine foam piece so that the SBL strap was available to engage a user's hand during use of the resulting example of a cleaning composite of the present invention.

It is anticipated that use of the above cleaning composite having a hand-engaging element will help facilitate effective cleaning and/or treating of surfaces during use. Prior to use, a user can insert his or her hand into the opening between the hand-engaging element and a surface of the remainder of the cleaning composite. For the particular prototype described above, the elastomeric SBL strap will help hold the remainder of the cleaning composite close to and/or in partial contact with a portion of the palm-side surface of a user's hand. Accordingly, it is anticipated that the preceding example will help: reduce the chances of a user dropping the cleaning composite during use and/or reduce the need for a user to firmly grip the cleaning composite during use and/or increase the effectiveness of cleaning and/or treating a surface because the user's palm-side surface of his or her hand is less likely to slip against the surface of the cleaning composite that is in contact with the user's hand.

It should be understood that the present invention includes various modifications that can be made to the embodiments of the cleaning composite as described herein as come within the scope of the appended claims and their equivalent

1. A cleaning composite comprising:
a foam layer having opposing surfaces;
a second layer having opposing surfaces, said second layer attached to at least a portion of one of said opposing surfaces of said foam layer; and
an element having a length and adapted to engage a hand, wherein the element is attached to the second layer, the foam layer, the interface between the second layer and the foam layer, or some combination thereof.

2. The cleaning composite of claim 1 wherein the element adapted to engage a hand is attached to the second layer, the foam layer, the interface between the second layer and the foam layer, or some combination thereof at two or more locations along the length of the element.

3. The cleaning composite of claim 2 wherein the foam layer is a melamine-based foam layer.

4. The cleaning composite of claim 3 wherein the second layer is a nonwoven material, a film material, a cellulosic material, a sponge material, a plastic, or some combination thereof.

5. The cleaning composite of claim 2 wherein the second layer is attached to at least a portion of said melamine-based foam layer with adhesive, ultrasonic bonds, stitches, hydroentanglement, or some combination thereof.

6. The cleaning composite of claim 3 wherein the element adapted to engage a hand is an elastomeric strap.

7. The cleaning composite of claim 6 wherein the elastomeric strap is attached to the second layer, the melamine-based foam layer, the interface between the second layer and the melamine-based foam layer, or some combination thereof using adhesive, ultrasonic bonds, stitches, hydroentanglement, or some combination of thereof.

8. The cleaning composite of claim 3 comprising additional elements adapted to engage a hand, each element having a length, wherein each additional element is attached to the second layer, the melamine-based foam layer, the interface between the second layer and the melamine-based foam layer, or some combination thereof at two or more locations along the length of each element.

9. The cleaning composite of claim 3 wherein the second layer, the melamine-based foam layer, or both comprise a functional element, a color-change element, or some combination thereof.

10. The cleaning composite of claim 3 wherein the element adapted to engage a hand is adjustable.

11. The cleaning composite of claim 3 wherein the element adapted to engage a hand comprises two pieces, each piece having a length, wherein a portion of each piece is attached to the second layer, the melamine-based foam layer, the interface between the second layer and the melamine-based foam layer, or some combination thereof, and wherein the pieces are adapted to releasably engage one another.

12. The cleaning composite of claim 11 wherein the pieces may be releasably engaged such that the engaged pieces are in facing relation to a surface of the melamine-based foam layer or a surface of the second layer.

13. The cleaning composite of claim 3 wherein the element adapted to engage a hand may be positioned in facing relation to a surface of the melamine-based foam layer or a surface of the second layer.

14. The cleaning composite of claim 1 wherein the foam layer is releasably engaged to the second layer.

15. A cleaning composite comprising:
a foam layer having opposing surfaces; and
an element having a length and adapted to engage a hand, wherein the element is attached to the foam layer.

16. The cleaning composite of claim 15 wherein the element adapted to engage a hand is attached to the foam layer at two or more locations along the length of the element.

17. The cleaning composite of claim 16 wherein the foam layer is a melamine-based foam layer.

18. The cleaning composite of claim 16 wherein the element adapted to engage a hand is an elastomeric strap.

19. The cleaning composite of claim 16 wherein the element is attached to the melamine-based foam layer using adhesive, ultrasonic bonds, stitches, hydroentangling, or some combination of thereof.

20. The cleaning composite of claim 16 comprising additional elements adapted to engage a hand, each element having a length, wherein each additional element is attached to the foam layer at two or more locations along the length of each element.

21. The cleaning composite of claim 16 wherein the melamine-based foam layer comprises a functional element, a color-change element, or some combination thereof.

22. The cleaning composite of claim 16 wherein the element adapted to engage a hand is adjustable.

23. The cleaning composite of claim 16 wherein the element adapted to engage a hand comprises two pieces, each piece having a length, wherein a portion of each piece is attached to the melamine-based foam layer, and wherein the pieces are adapted to releasably engage one another.
